(19) United States
(12) Patent Application Publication
(10) Pub. No.: US 2008/0031578 A1
(43) Pub. Date: Feb. 7, 2008

(54) PACKAGING FOR ENCASING AN OPTICAL FIBER IN A CABLE

(76) Inventors: Joseph Varkey, Missouri City, TX (US); Garud Sridhar, Stafford, TX (US)

Correspondence Address: SCHLUMBERGER IPC;ATTN: David Cate, 555 INDUSTRIAL BOULEVARD, MD-21, SUGAR LAND, TX, 77478, US

(21) Appl. No.: 11/461,943

(22) Filed: Aug. 2, 2006

(51) Int. Cl. G02B 6/44

(52) U.S. Cl. 385/100

(57) ABSTRACT

A cable component is provided that includes at least one optical fiber; and a plurality of shaped profiles having inner and outer surfaces such that the inner surfaces combine to from an enclosure for the at least one optical fiber.

### FIELD OF THE INVENTION

The present invention relates generally to a cable component having an optical fiber encased therein, and more particularly to such a cable component having a plurality of shaped profiles which combine to form an enclosure for an optical fiber.

### BACKGROUND

In the oil and gas well industry tools are often lowered in a well by a cable (commonly referred to as a wireline or a wireline cable) for the purpose of monitoring or determining characteristics of the well. Once data is collected by the tool, it is sent from the wellbore to the surface of the well through the cable. Recently, it has been discovered that optical fibers are able to transmit data from a wellbore to the surface of a well at a much faster rate than electrical data transmission lines. As such, it is desirable to include optical fibers in oil and gas well wireline cables for the purpose of data transmission. However, several characteristics of optical fibers make them vulnerable to damage in oilfield operations.

For example, exposure to hydrogen at high temperatures results in a “darkening” of optical fibers, which leads to a reduction in data carrying capacity. The difference in linear stretching of optical fibers as compared to the other components of the cable requires additional fiber length to be built in to the optical fiber components, which complicates the manufacturing process. Volatilization of volatile organic compounds (VOCs) in coatings or other polymeric protective layers on the optical fibers releases additional hydrogen which can attack and darken the fibers. Optical fibers are susceptible to hydrolytic attack in the presence of water. A lack of transverse toughness of optical fiber component construction leads to potential point loading and micro-bending issues, which can lead to mechanical failure of the optical fibers and/or increased data attenuation.

One technique used to protect optical fibers from many of the problems listed above is to encase them in a solid metallic tube. However, encasing an optical fiber in a metallic tube has several disadvantages. For example, encasing an optical fiber in a metallic tube is very expensive. End to end welding of metallic tubes, which is necessary to create a wireline cable of a sufficient length, creates difficult-to-detect pinholes. Such welding also produces welding gases, which if trapped inside the tube can lead to deterioration of the optical fibers inside the tube.

In addition, when subjected to torque (which is present in most wireline cables) solid metallic tubes are prone to collapse unless they are excessively thick, as such the tube must be sufficiently thick to prevent collapse under such torque and/or other loads or pressures. However, such added thickness takes up valuable space within the cable core. Also, solid metallic tubes have limited flexibility, and a low fatigue life in dynamic applications; and optical fibers encased in metallic tubes cannot be spliced without over-sizing them. Accordingly, a need exists for an improved method and/or apparatus for encasing an optical fiber in a cable.

### SUMMARY

In one embodiment, the present invention is a cable that includes at least one optical fiber; and a plurality of shaped profiles having inner and outer surfaces such that the inner surfaces combine to from an enclosure for the at least one optical fiber.

In another embodiment, the present invention is a cable component that includes at least one optical fiber; a soft polymer layer disposed about an outer surface of the at least one optical fiber; a plurality of electrically conductive shaped profiles having inner and outer surfaces such that the inner surfaces combine to from an enclosure for the at least one optical fiber; and an outer insulation layer formed around the outer surfaces of the plurality of shaped profiles, wherein the soft polymer layer over the fiber at least substantially fills an area between the inner surfaces of the plurality of shaped profiles and the outer surface of the at least one optical fiber.

In yet another embodiment, the present invention is a cable component including at least one optical fiber; a core having at least one peripheral groove that extends substantially along the length of the cable component, wherein the at least one peripheral groove receives the at least one optical fiber; and a protective material disposed in surrounding relation to both the at least one optical fiber and the core.

In yet another embodiment, the present invention is a method of manufacturing a cable component that includes forming a plurality of shaped profiles having inner and outer surfaces such that the inner surfaces combine to from an enclosure; and placing at least one optical fiber in said enclosure.

### BRIEF DESCRIPTION OF THE DRAWINGS

These and other features and advantages of the present invention will be better understood by reference to the following detailed description when considered in conjunction with the accompanying drawings wherein:

FIG. 1A is a radial cross-sectional view of a cable component according to one embodiment of the present invention for encasing an optical fiber;

FIG. 1B is a longitudinal side view of the cable component of FIG. 1A;

FIG. 2A is a radial cross-sectional view of a cable component according to another embodiment of the present invention for encasing an optical fiber;

FIG. 2B is a longitudinal side view of the cable component of FIG. 2A;

FIG. 3A is a radial cross-sectional view of a cable component according to another embodiment of the present invention for encasing an optical fiber;

FIG. 3B is a longitudinal side view of the cable component of FIG. 3A;

FIG. 4A is a radial cross-sectional view of a cable component according to another embodiment of the present invention for encasing multiple optical fibers;

FIG. 4B is a longitudinal side view of the cable component of FIG. 4A;

FIG. 5 is a radial cross-sectional view of a cable component according to another embodiment of the present invention showing shaped profiles with mating ends for encasing an optical fiber;

FIG. 6 is a radial cross-sectional view of a cable component according to another embodiment of the present invention showing “arched pie-shaped” profiles for encasing an optical fiber;

FIG. 7 is a radial cross-sectional view of a cable component according to another embodiment of the present invention showing keystone shaped profiles for encasing an optical fiber;

FIG. 8 is a radial cross-sectional view of a cable component according to another embodiment of the present invention showing triangular shaped profiles for encasing an optical fiber;

FIG. 9 is a radial cross-sectional view of a cable component according to another embodiment of the present invention showing rectangular shaped profiles for encasing an optical fiber;

FIG. 10 is a radial cross-sectional view of a cable component according to another embodiment of the present invention for encasing an optical fiber;

FIG. 11 is a radial cross-sectional view of a cable component according to another embodiment of the present invention showing a hinged connection to a pair of shaped profiles for encasing an optical fiber;

FIG. 12 is a radial cross-sectional view of a cable component according to another embodiment of the present invention showing a snap fit, ball and joint, connection to a pair of shaped profiles for encasing an optical fiber;

FIG. 13 is a radial cross-sectional view of a cable component according to another embodiment of the present invention showing a snap fit, dovetail, connection to a pair of shaped profiles for encasing an optical fiber;

FIG. 14 is a radial cross-sectional view of a cable component according to one embodiment of the present invention having a solid core with one or more longitudinal grooves therein for receiving an optical fiber therein;

FIGS. 15-16 and 19-22 show a method of making the cable component of FIG. 14;

FIGS. 17-22 show another method of making the cable component of FIG. 14;

FIGS. 23A-23AJ show various alternative shapes of the core of the cable component of FIG. 14; and

FIG. 24 shows a cable having a plurality of cable components according to the present invention disposed therein.

### DETAILED DESCRIPTION OF EMBODIMENTS OF THE INVENTION

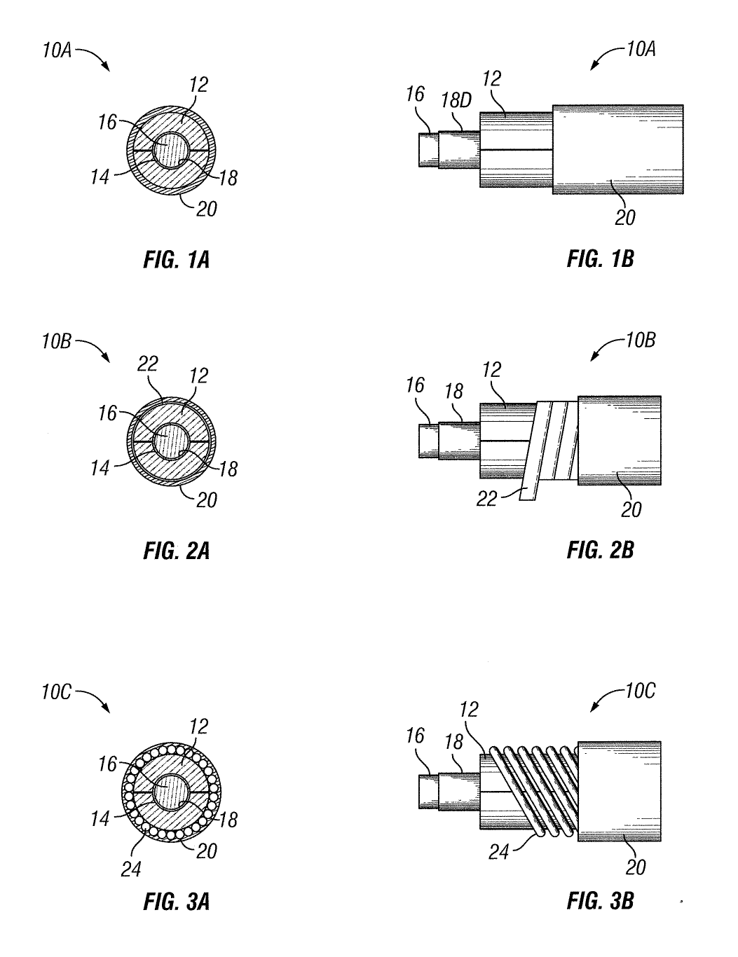

As shown in FIGS. 1-24, embodiments of the present invention are directed to a cable component having an optical fiber encased therein. In one embodiment, the cable includes a plurality of shaped profiles that are shaped and positioned such that in combination they form an enclosure for encasing an optical fiber therein. In one embodiment, the cable component forms a portion of a wireline cable for use in oil and gas well applications. In such an application, the encased optical fiber may be used to transmit data from a wellbore to a surface of a well. In one embodiment the cable is approximately 10,000 to approximately 45,000 feet in length. Note that in showing and describing the various embodiments of the present invention, like or identical reference numerals are used to identify common or similar elements.

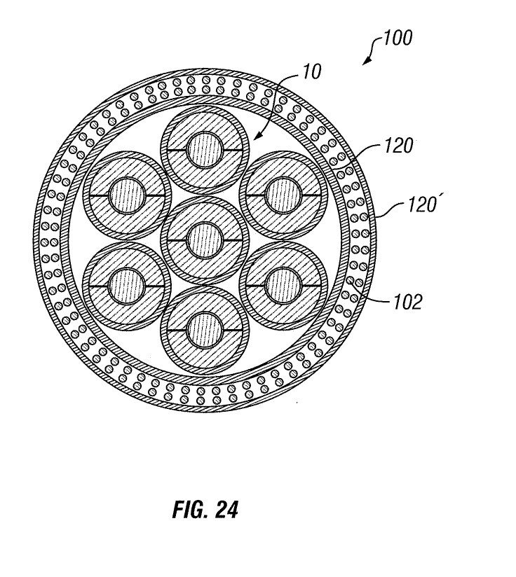

FIGS. 1A-1B show a cable component 10A according to one embodiment of the present invention. As described in further detail below, the cable component 10A of FIGS. 1A-1B, as well as any of the various alternative embodiments of FIGS. 2A-23AJ, may be encased in a cable 100 as shown in FIG. 24. Referring back to FIGS. 1A-1B, the cable component 10A includes a plurality of shaped profiles 12, wherein a profile is defined as the shape of an object in cross section. The shaped profiles 12 are shaped and positioned relative to one another to combine to form an enclosure 14 for receiving an optical fiber 16. In the depicted embodiment, the inner surfaces of the shaped profiles 12 combine to form a enclosure 14, which is substantially circular.

In one embodiment, the shaped profiles 12 are formed by a cold forming process, such as a drawing process, an extrusion process, a rolling process, or any combination thereof, among other appropriate processes. These shaped profiles 12 may be composed of a conductive material, such as a metallic material, for example stainless steel, copper, steel or copper-clad steel, among other appropriate materials. These materials may be in the form of single or stranded wires. Alternatively, the shaped profiles 12 may be composed of any other appropriate material, such as a polymeric material. The shaped profiles 12 provide hoop strength to the cable component 10A. In addition, in embodiments where the shaped profiles 12 are composed of a conductive material, the shaped profiles 12 can be used as electrical conductors to send electrical signals, to transmit power, and/or to transmit data. This can be done in addition to the optical fiber 16 being used to transmit data/and or power.

Within the enclosure 14 formed by the shaped profiles 12 is the optical fiber 16. The optical fiber 16 may be any appropriate single or multi-mode optical fiber. Commercially available optical fibers 16 typically include an outer coating such as an acrylic coating, or silicon followed by a perfluoroalkoxy resin (PFA) coating. As such, unless otherwise specified, the term optical fiber includes this outer coating.

As shown in FIGS. 1A-1B, an insulation layer 18 may be placed about the optical fiber 16. To avoid duplicity, the layer 18 is referred to hereinafter as an insulation layer, however, layer 18 may be an insulation layer and/or a cushioning or space filling layer, such as a soft polymer layer. In one embodiment, the insulation layer 18 fills the area between the inner surfaces of the shaped profiles 12 and the outer surface of the optical fiber 16. The insulation layer 18 cushions the optical fiber 16 and protects it from damage by the inner surfaces of the shaped profiles 12. The insulation layer 18 may be composed of a soft thermoplastic material, a thermoplastic elastomer, a rubber material and/or a gel, among other appropriate materials. In one embodiment, the insulation layer 18 is composed of soft silicone or another soft polymer with similar properties.

Disposed about the outer surface of the shaped profiles 12 is an outer insulation layer 20. The outer insulation layer 20 holds the shaped profiles 12 together and improves the durability and manufacturability of the cable component 10A. In one embodiment, the shaped profiles 12 are “physically independent.” That is, the shaped profiles 12 are separate parts that are not coupled, joined or bonded together, but instead are merely held together by the outer insulation layer 20.

In one embodiment, the outer insulation layer 20 is composed of a polymer having a reasonably high melting temperature such that it does not melt in the high temperature environments of typical oil and gas wells. For example, the outer insulation layer 20 may be composed of a polymeric material or a hard plastic material, for example polyetheretherketone (PEEK), or another fluoropolymer, for example tefzel®, a perfluoroalkoxy resin (PFA), a fluorinated ethylene propylene copolymer (FEP), tetrafluoroethylene (TFE), perfluoromethylvinylether copolymer (MFA), or among other appropriate polymers and/or fluoropolymers. The insulation layer 20 may have more than one polymer disposed in such a way as to meet stacked di-electric concepts.

Although not shown, the cable component 10A may further include an outer metallic shell. This outer metallic shell may be an extruded metallic shell composed of lead, or an alloy such as tin-zinc, tin-gold, tin-lead, or tin-silver, among other appropriate materials. The metallic shell may be disposed over the outer insulation layer 20 or between the shaped profiles 12 and the outer insulation layer 20.

In one embodiment, the cable component 10A is manufactured by encasing the optical fiber 16 in an insulation layer 18; and placing multiple shaped profiles 12 around the optical fiber 16 and the insulation layer 18 to form an enclosure 14 around the optical fiber 16 and its insulation layer 18. The outer insulation layer 20, such as a layer of a hard plastic material, is then extruded over the shaped profiles 12 to hold or lock the shaped profiles 12 in place over the optical fiber 16.

In one embodiment, prior to placing the shaped profiles 12 about the optical fiber 16 and its insulation layer 18, the insulation layer 18 is in a liquid form such as an uncured silicone. In such a case, when the shaped profiles 12 are placed about the optical fiber 16 and its insulation layer 18, the liquid insulation layer 18 is allowed to fill the enclosure 14 in the area between the inner surfaces of the shaped profiles 12 and the outer surface of the optical fiber 16. The insulation layer 18 can then be hardened by curing to hold its shape between the shaped profiles 12 and the optical fiber 16.

FIGS. 2A-2B show a cable component 10B. The cable component 10B of FIGS. 2A-2B may include each of the components and various embodiments as described above with respect to the cable component 10A in FIGS. 1A-1B. However, the cable component 10B of FIGS. 2A-2B additionally includes a layer of tape 22 between the shaped profiles 12 and the outer insulation layer 20. In such an embodiment, the tape 22 is wrapped around the shaped profiles 12 to hold them together while the outer insulation layer 20, such as a layer of a hard plastic material, is extruded over the tape 22 and the shaped profiles 12. In such an embodiment, the cable component 10B may be wrapped around a spool after applying the tape 22 so that the cable component 10B can be moved to a separate production line to apply the extruded hard plastic jacket 20.

FIGS. 3A-3B show a cable component 10C. The cable component 10C of FIGS. 3A-3B may include each of the components and various embodiments as described above with respect to the cable component 10A in FIGS. 1A-1B. However, the cable component 10C of FIGS. 3A-3B additionally includes a layer of wrapped wire 24 between the shaped profiles 12 and the outer insulation layer 20. In such an embodiment, the wrapped wire 24 is cabled helically around the shaped profiles 12 at a helix angle to hold the shaped profiles 12 together and prevent them from radially moving while the outer insulation layer 20, such as a layer of a hard plastic material, is extruded over the wrapped wire 22 and the shaped profiles 12.

In one embodiment, the wrapped wire 24 is composed of a conductive material, such as a metal for example copper, copper-clad steel, or steel, among other appropriate materials. Alternatively, the wrapped wire 24 may be composed of any other appropriate material, such as a polymeric material or a twisted yarn. However, in embodiments where the wrapped wire 24 is composed of a conductive material, the wrapped wire 24 serves to minimize thermal expansion along the longitudinal axis of the cable component 10C and may serve as an electrical conductor capable of sending electrical signals, to transmitting power, and/or transmitting data. As with the cable component 10B of FIGS. 2A-2B, with the cable component 10C of FIGS. 3A-3B, the cable component 10C may be wrapped around a spool after applying the wrapped wire 24 so that the cable component 10C can be moved to a separate production line to apply the extruded hard plastic jacket 20.

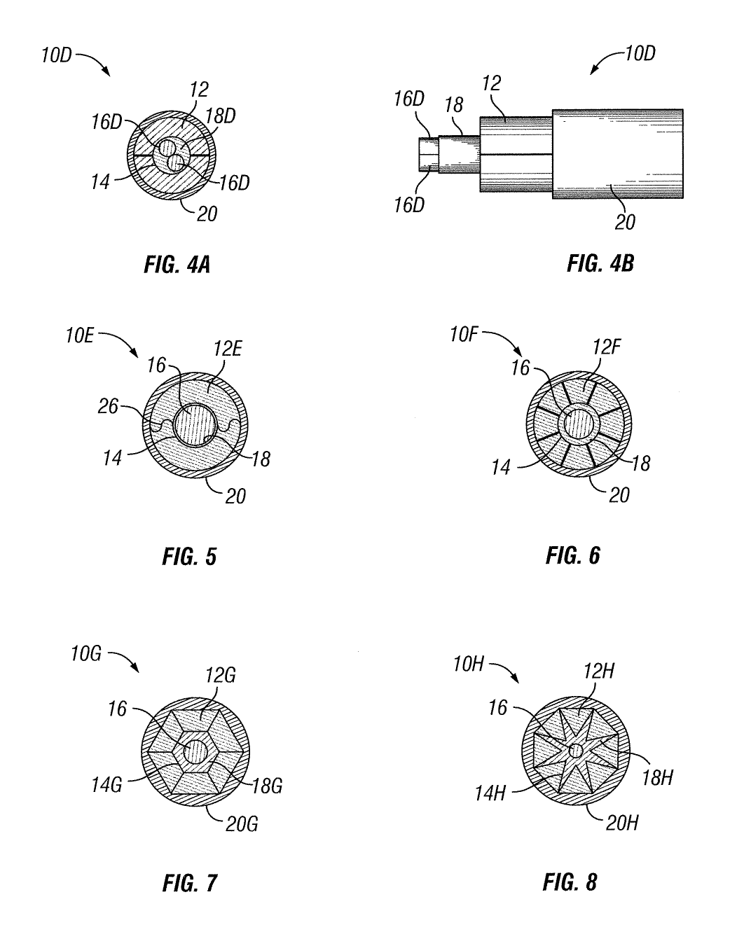

Although each of the above cable components 10A-10C includes only one optical fiber 16, any of the cable components according to the present invention, including those described both above and below, may include any appropriate number of optical fibers 16. For example, FIGS. 4A-4B show a cable component 10D having two optical fibers 16D encased therein. As shown, in this embodiment the shaped profiles 12 combine to form an enclosure 14 that does not snuggly fit about the optical fibers 16D. In such an embodiment, an insulation layer 18D may be formed around the optical fibers 16D by any appropriate method to fill the area between the inner surfaces of the shaped profiles 12 and the outer surfaces of the optical fibers 16D.

For example, in one embodiment prior to placing the shaped profiles 12 about the optical fibers 16D and their insulation layer 18D, the insulation layer 18D is in a liquid form such as an uncured silicone. In such a case, when the shaped profiles 12 are placed about the optical fibers 16D and their insulation layer 18D, the liquid insulation layer 18D is allowed to fill the enclosure 14 in the area between the inner surfaces of the shaped profiles 12 and the outer surface of the optical fibers 16D. The insulation layer 18D can then be hardened by curing to hold its shape between the shaped profiles 12 and the optical fibers 16D. In this way, the insulation layer 18D occupies the entire space between the inner surfaces of the shaped profiles 12 and the outer surface of the optical fibers 16D. In all other respects the cable component 10D of FIGS. 4A-4B may include each of the components and various embodiments described above with respect to the cable components 10A-10C in FIGS. 1A-3B.

In each of the above described cable components 10A-10D, the shaped profiles 12 include two semi-circular shaped profiles which together form a hollow cylinder, with a circular shaped enclosure 14 for receiving one or more optical fibers 16. FIG. 5 shows a cable component 10E having two semi-circular shaped profiles 12E, wherein the ends of each shaped profile 12E have complementary surfaces 26 which mate to prevent the shaped profiles 12E from moving relative to one another in the radial direction. In all other respects the cable component 10E of FIG. 5 may include each of the components and various embodiments described above with respect to the cable components 10A-10D in FIGS. 1A-4B.

FIG. 6 shows a cable component 10F having shaped profiles 12F which together form a hollow cylinder, with circular inner and outer surfaces, the inner surfaces forming an enclosure 14 for receiving an optical fiber 16. In this embodiment, the shaped profiles 12F may be referred to as being “arched pie-shaped.” As opposed to previous embodiments, where the shaped profiles include two semi-circular shaped profiles, in this embodiment the arched pie-shaped profiles 12F include more than two shaped profiles.

For example, in the depicted embodiment, the shaped profiles 12F include eight arched pie-shaped profiles 12F. However, in other embodiments any appropriate number of arched pie-shaped profiles 12F may be used, the advantage being the greater the number of shaped profiles 12F, the greater the compression resistance and the greater the flexibility of the cable component 10F. In all other respects the cable component 10F of FIG. 6 may include each of the components and various embodiments described above with respect to the cable components 10A-10E in FIGS. 1A-5.

FIG. 7 shows a cable component 10G having shaped profiles 12G which together form an enclosure 14G for receiving an optical fiber 16. In this embodiment, the each of the shaped profiles 12G has an isosceles trapezoid or “keystone” shaped profile. As a result, the keystone shaped profiles 12G combine to form a hollow polygon, with both the inner and outer surfaces of the combined shaped profiles 12G forming polygonal rather than circular shapes as in previous embodiments.

In this embodiment, the insulation layer 18G around the optical fiber 16 is circular adjacent to the optical fiber 16 and polygonal adjacent to the inner surfaces of the keystone shaped profiles 12G. This can be achieved by any appropriate method, such as the above described method of filling the area between the inner surfaces of the shaped profiles 12G and the outer surface of the optical fiber 16 with a liquid insulator and curing the insulator in place.

In one embodiment, after the keystone shaped profiles 12G are placed around the optical fiber 16 and its insulation layer 18G (and the insulation layer 18G is cured if that method is used), an outer insulation layer 20G, such as a polymeric layer, is compression extruded over the shaped profiles 12G to hold the shaped profiles 12G in place and to create a circular outer profile for the cable component 10G.

In the depicted embodiment, the shaped profiles 12G include six keystone shaped profiles 12G. However, in other embodiments any appropriate number of keystone shaped profiles 12G may be used. Such keystone shaped profiles 12G produce a cable component 10G that is much more flexible and compression resistant that a cable component having an optical fiber encased in a solid metallic tube. In all other respects, the cable component 10G of FIG. 7 may include each of the components and various embodiments described above with respect to the cable components 10A-10E in FIGS. 1A-5.

FIG. 8 shows a cable component 10H having shaped profiles 12H which together form an enclosure 14H for receiving an optical fiber 16. In this embodiment, the each of the shaped profiles 12H has a triangular shaped profile, with the inner surface of the combined shaped profiles 12H forming a “star-shaped” enclosure 14H.

In this embodiment, the insulation layer 18H may conform to the area between the inner surface of the shaped profiles 12H and the optical fiber 16 by any appropriate method, such as any of those described above. In addition, the outer insulation layer 20H may conform to the outer surface of the shaped profiles 12H and form a circular outer profile for the cable component 10H by any of the methods described above.

In the depicted embodiment, the shaped profiles 12H include eight triangular shaped profiles 12H. However, in other embodiments any appropriate number of triangular shaped profiles 12H may be used. Such triangular shaped profiles 12H produce a cable component 10H that is much more flexible and compression resistant than a cable component having an optical fiber encased in a solid metallic tube. In all other respects the cable component 10H of FIG. 8 may include each of the components and various embodiments described above with respect to the cable components 10A-10E in FIGS. 1A-5.

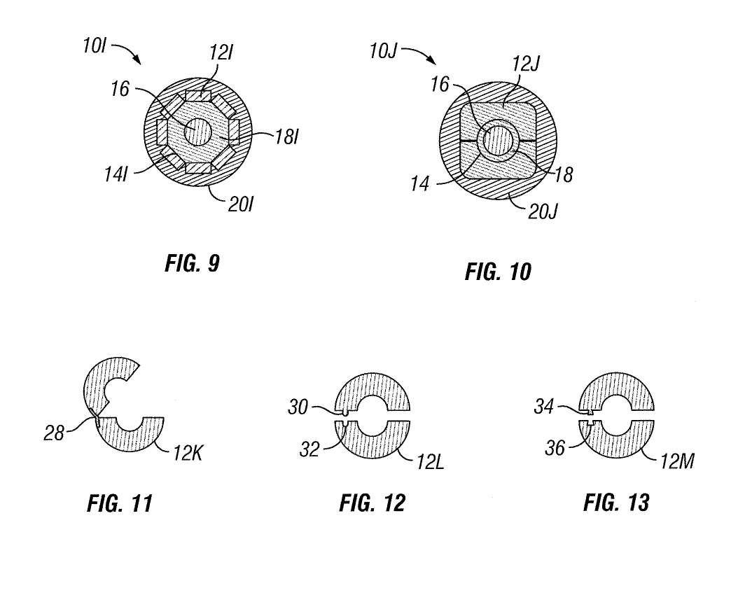

FIG. 9 shows a cable component 10I having shaped profiles 12I which together form an enclosure 14I for receiving an optical fiber 16. In this embodiment, each of the shaped profiles 12I has a rectangular shaped profile. As a result, the inner surfaces of the rectangular shaped profiles 12I combine to form a polygonal shaped enclosure 14I similar to that described above with respect to the cable component 10G of FIG. 7.

In this embodiment, the insulation layer 18I may conform to the area between the inner surface of the rectangular shaped profiles 12I and the optical fiber 16 by any appropriate method, such as any of those described above. In addition, the outer insulation layer 20I may conform to the outer surface of the rectangular shaped profiles 12I and form a circular outer profile for the cable component 10I by any of the methods described above.

In the depicted embodiment, the shaped profiles 12I include eight rectangular shaped profiles 12I. However in other embodiments any appropriate number of rectangular shaped profiles 12I may be used. Such rectangular shaped profiles 12I produce a cable component 10I that is much more flexible and compression resistant than that of a cable component having an optical fiber encased in a solid metallic tube. In all other respects the cable component 10I of FIG. 9 may include each of the components and various embodiments described above with respect to the cable components 10A-10E in FIGS. 1A-5.

FIG. 10 shows a cable component 10J having shaped profiles 12J which together form an enclosure 14 for receiving an optical fiber 16. In this embodiment, the shaped profiles 12J are formed in halves similar to the shaped profiles 12 shown in FIGS. 1A-1B, a difference being that the outer surfaces of the shaped profiles 12J in FIG. 10 combined to form a rectangular or square profile, whereas the outer surfaces of the shaped profiles 12 in FIGS. 1A-1B combined to form a circular profile. The outer insulation layer 20J of FIG. 10 may conform to the outer surface of the shaped profiles 12J and form a circular outer profile for the cable component 10J by any of the methods described above. In all other respects the cable component 10J of FIG. 10 may include each of the components and various embodiments described above with respect to the cable components 10A-10E in FIGS. 1A-5.

The embodiment of FIG. 11 includes semi-circular shaped profiles 12K connected by a hinge 28. The hinge 28 allows the shaped profiles 12K to be separated to accept a optical fiber 16 and its insulation layer 18; and subsequently closed to allow a outer insulation layer 20 to be formed therearound.

The embodiment of FIG. 12 includes semi-circular shaped profiles 12L connected by a snap fit connection, such as a ball and joint connection 30,32. The ball and joint connection 30,32 allows the shaped profiles 12L to be separated to accept a optical fiber 16 and its insulation layer 18; and subsequently closed to allow a outer insulation layer 20 to be formed therearound.

The embodiment of FIG. 13 includes semi-circular shaped profiles 12M connected by a snap fit connection, such as a dovetail connection 34,36. The dovetail connection 34,36 allows the shaped profiles 12M to be separated to accept a optical fiber 16 and its insulation layer 18; and subsequently closed to allow a outer insulation layer 20 to be formed therearound.

Note that any of the cable components 10A-10J in any of the embodiments described above with respect to FIGS. 1-10 may include any of the connection mechanisms as shown and described with respect to FIGS. 11-13. Also note that in any of the embodiments described above, if the optical fiber 16 fits snugly within its corresponding enclosure (such as that shown in FIGS. 1A-3B, 5-6, and 10 for example), the insulation layer 18 around the optical fiber 16 may not be needed.

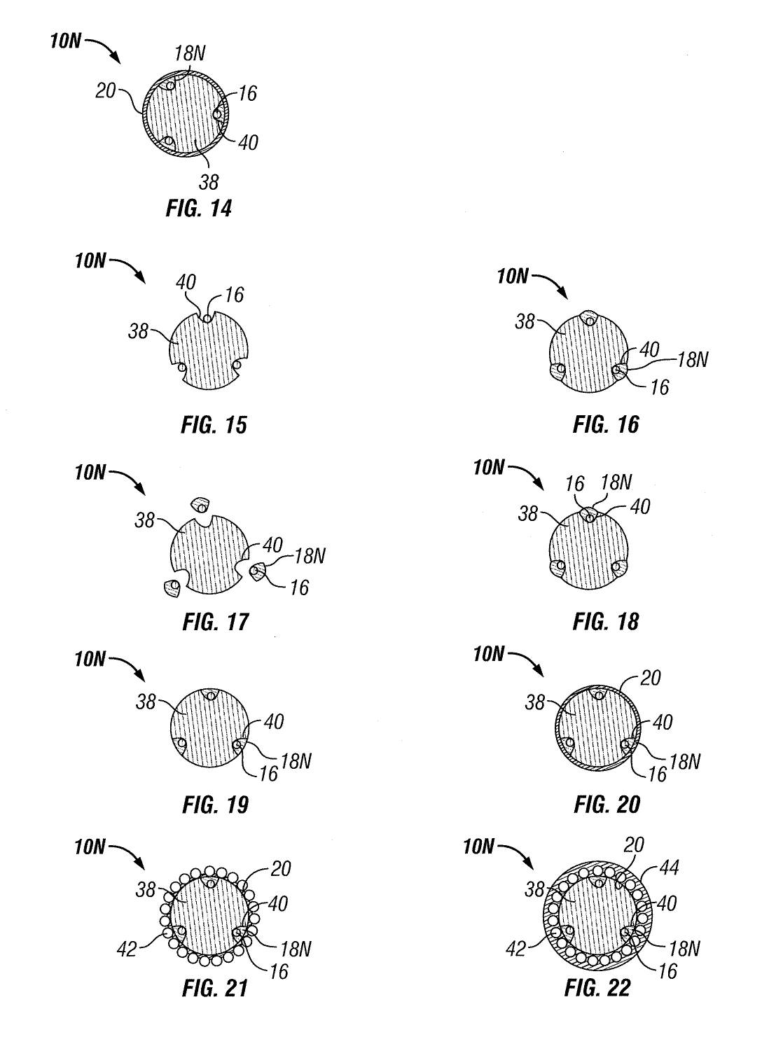

FIG. 14 shows a cable component 10N having a core 38 with peripheral grooves 40. These grooves 40 extend along the length of the cable component 10N, preferable parallel to the longitudinal axis thereof. The core 38 may be composed of a conductive material, such as a metal, for example stainless steel, copper, steel, or copper-clad steel, among other appropriate materials. Alternatively, the core 38 may be composed of any other appropriate material, such as a polymeric material. However, in embodiments where the core 38 is composed of a conductive material, the core 38 can be used as an electrical conductor to send electrical signals, to transmit power, and/or to transmit data.

Each groove 40 in the core 38 receives an optical fiber 16, which is surrounded by a insulation layer 18N. Although three grooves 40, each with one optical fiber 16 disposed therein, are shown. The core 38 may include any appropriate number of grooves 40, and each groove 40 may contain any appropriate number of optical fibers 16 disposed therein.

The optical fiber 16 and the insulation layer 18N may be any of those describe above with respect to FIGS. 1A-1B. In addition, the insulation layer 18N may be applied to the optical fiber 16 as in any of the methods described above. An outer insulation layer 20 may be applied over the optical fibers 16 to hold them in place in the grooves 40. The outer insulation layer 20 may be applied by any of the methods described above.

FIGS. 15-22 show methods of making the cable component 10N of FIG. 14. For example, in one embodiment, as shown in FIG. 15, the optical fibers 16 are positioned in their respective grooves 40; and then, as shown in FIG. 16, an insulator 18N, such as a liquid polymer is applied to each optical fiber 16. Alternatively, as shown in FIG. 17, each optical fiber 16 is encased in an insulator 18N, such as a liquid polymer; and then, as shown in FIG. 18, each optical fiber 16 with its applied insulator 18N is placed in a respective one of the grooves 40.

In either method, portions of the insulator 18N that extend past the outer surface of the non-grooved portions of the cable component 10N are removed, as shown in FIG. 19, such as by wiping off the excess. Thus, the insulator 18N is flush with the outer surface of the non-grooved portions of the cable component 10N. In embodiments where the insulator 18N is applied in liquid form, it may now be cured to hold its shape. As shown in FIG. 20, the outer insulation layer 20 may then be applied over the optical fibers 16 by any method described above in order to hold the optical fibers 16 in place in their grooves 40.

As shown in FIG. 21 a conductive material 42, such as a metal, may then be applied over the outer insulation layer 20. The conductive material 42 may be any appropriate material, such as stainless steel, copper, steel or copper-clad steel, among other appropriate materials. In one embodiment, the metallic material 42 is cabled helically over the outer insulation layer 20. In one embodiment the conductive material 42 is partially embedded into the outer insulation layer 20. In another embodiment, the conductive material 42 is applied directly over the core 38 and the optical fibers 16 without the use of the outer insulation layer 20.

In either event, as shown in FIG. 22, a second outer insulation layer 44 is applied over the conductive material 42. The second outer insulation layer 44 may be composed of any of the material described above with respect to the outer insulation layer 20 described in FIGS. 1A-1B ahead. In addition, the second outer insulation layer 44 may be applied by any of the methods described above with respect to the outer insulation layer 20. Preferably, the second outer insulation layer 44 has a circular outer surface.

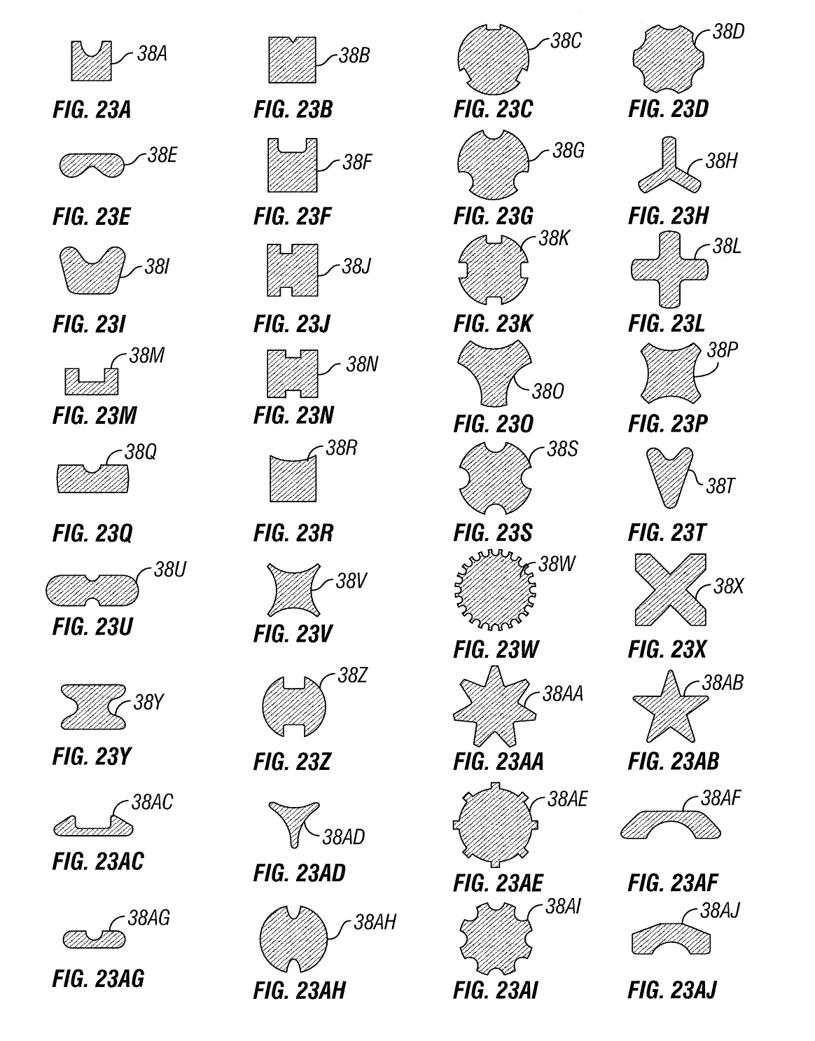

FIGS. 23A-23AJ shows a variety of core shapes 38A-38AJ that may be used in any of the embodiments of the cable component 10N as described with respect to FIGS. 14-22. Each of the depicted cores 38A-38AJ may be produced by a cold forming process, such as a drawing process, an extrusion process or a rolling process, or any combination thereof, among other appropriate manufacturing techniques. As shown, each of these cores 38A-38AJ includes at least one groove for receiving an optical fiber. In addition, the shape of the core 38 in the cable component 10N of FIGS. 14-22 is not intended to be limited to the shapes shown in FIGS. 23A-23AJ. Instead, the depicted shapes are merely shown as exemplary shapes.

The cable components in each of the embodiments described above may provide one or more advantages over cable components which incorporate optical fibers encased in a solid metal tube including: decreased expense, increased manufacturability, increased compression resistance, increased crush resistant, smaller cross sectional area, able to completely seal the encased optical fiber(s), able to be sliced while maintaining a relatively small cross sectional area, and increased flexibility.

FIG. 24 shows a cable 100 having a plurality of cable components 10 according to the present invention. Note that although the depicted cable 100 includes seven cable components 10, the cable 100 may include any appropriate number of cable components 10. Also note that the plurality of cable components 10 may include any combination of one or more of any of the cable components 10A-10N described above.

In addition, any of the cable components 10 may be replaced by an insulated conductor that does not include an optical fiber, such as an insulated copper wire. Such an insulated conductor may be used to send electrical signals, to transmit power, and/or to transmit data.

In one embodiment, the cable 100 is suitable for use in oil exploration such as a seismic cable, a wireline cable, a slickline cable, or a multi-line cable, amount other suitable cables. In the depicted embodiment, the cable components 10 are encased in a first insulation or jacket layer 120 and a second insulation or jacket layer 120′. Sandwiched between the insulation layers is a reinforcement layer 102. The reinforcement layer 102 may be composed of any material appropriate for adding strength to the cable, such as a metallic wire, which may be helically wrapped around the first insulation layer 120.

The first and second insulation layers 120,120′ may be composed of any of the material described above with respect to the outer insulation layer 20 described in FIGS. 1A-1B ahead. In addition, the first and second insulation layers 120,120′ may be applied by any of the methods described above with respect to the outer insulation layer 20. Not that in some embodiments it may not be necessary to include the second insulation layer 120′.

Cables according to the invention may be used with wellbore devices to perform operations in wellbores, penetrating geologic formations that may contain gas and oil reserves. The cables may be used to interconnect well logging tools, such as gamma-ray emitters/receivers, caliper devices, resistivity measuring devices, seismic devices, neutron emitters/receivers, and the like, to one or more power supplies and data logging equipment outside the well. Cables of the invention may also be used in seismic operations, including subsea and subterranean seismic operations, the cables may also be useful as permanent monitoring cables for wellbores.

The preceding description has been presented with reference to presently preferred embodiments of the invention. Persons skilled in the art and technology to which this invention pertains will appreciate that alterations and changes in the described structures and methods of operation can be practiced without meaningfully departing from the principle, and scope of this invention. Accordingly, the foregoing description should not be read as pertaining only to the precise structures described and shown in the accompanying drawings, but rather should be read as consistent with and as support for the following claims, which are to have their fullest and fairest scope.

1. A cable component comprising:
at least one optical fiber; and
a plurality of shaped profiles having inner and outer surfaces such that the inner surfaces combine to from an enclosure for the at least one optical fiber.

2. The cable component of claim 1, wherein the plurality of shaped profiles comprise an electrically conductive material.

3. The cable component of claim 1, wherein the plurality of shaped profiles comprise a metallic material.

4. The cable component of claim 1, wherein the plurality of shaped profiles are physically independent.

5. The cable component of claim 1, further comprising an outer insulation layer formed around the outer surfaces of the plurality of shaped profiles.

6. The cable component of claim 5, wherein the plurality of shaped profiles are held together by the outer insulation layer and are not otherwise connected to each other on at least one pair of adjacent sides thereof.

7. The cable component of claim 5, further comprising a stabilizing layer wrapped around the outer surfaces of the plurality of shaped profiles between said outer surfaces and said outer insulation layer.

8. The cable component of claim 7, wherein the stabilizing layer is electrically conductive.

9. The cable component of claim 5, further comprising a cushioning layer disposed about an outer surface of the at least one optical fiber.

10. The cable component of claim 9, wherein the cushioning layer at least substantially fills an area between the inner surfaces of the plurality of shaped profiles and the outer surface of the at least one optical fiber.

11. The cable component of claim 1, wherein said enclosure has a shape chosen from the group consisting of circular, polygonal and star shaped.

12. The cable component of claim 11, wherein the outer surfaces of the shaped profiles combine to form a shape chosen from the group consisting of circular, polygonal and rectangular.

13. The cable component of claim 1, wherein each of the plurality of shaped profiles has a shape chosen from the group consisting of an arched pie shape, a keystone shape, a triangular shape, and a rectangular shape.

14. The cable component of claim 1, wherein the at least one optical fiber and the plurality of shaped profiles each extend substantially along the length of the cable component.

15. The cable component of claim 1, wherein the cable component is disposed in a cable for use in an oil and gas well chosen from the group consisting of a seismic cable, a wireline cable, a slickline cable and a multi-line cable.

16. A cable component comprising:
at least one optical fiber;
a soft polymer layer disposed about an outer surface of the at least one optical fiber;
a plurality of electrically conductive shaped profiles having inner and outer surfaces such that the inner surfaces combine to from an enclosure for the at least one optical fiber; and
an outer insulation layer formed around the outer surfaces of the plurality of shaped profiles, wherein the soft polymer layer at least substantially fills an area between the inner surfaces of the plurality of shaped profiles and the outer surface of the at least one optical fiber.

17. A cable component comprising:
at least one optical fiber;
a core comprising at least one peripheral groove that extends substantially along the length of the cable component, wherein the at least one peripheral groove receives the at least one optical fiber; and
a protective material disposed in surrounding relation to both the at least one optical fiber and the core.

18. The cable component of claim 17, wherein at least one of the core and the protective material comprises an electrically conductive material.

19. The cable component of claim 17, wherein at least one of the core and the protective material comprises a metallic material.

20. The cable component of claim 17, wherein the protective material is a metallic wire that is helically wrapped around both the at least one optical fiber and the core

21. The cable component of claim 18, further comprising an outer insulation layer formed around the protective material.

22. The cable component of claim 21, further comprising a cushioning layer disposed about an outer surface of the at least one optical fiber.

23. The cable component of claim 17, wherein the cable component is disposed in a cable for use in an oil and gas well chosen from the group consisting of a seismic cable, a wireline cable, a slickline cable and a multi-line cable.

24. A method of manufacturing a cable component comprising:
forming a plurality of shaped profiles having inner and outer surfaces such that the inner surfaces combine to from an enclosure; and
placing at least one optical fiber in said enclosure.

25. The method of claim 24, wherein said forming comprises forming the plurality of shaped profiles from an electrically conductive material.

26. The method of claim 24, wherein said forming comprises forming the plurality of shaped profiles from a metallic material.

27. The method of claim 25, wherein said forming comprises forming the plurality of shaped profiles in a cold forming process.

28. The method of claim 24, further comprising applying an outer insulation layer around the outer surfaces of the plurality of shaped profiles.

29. The method of claim 28, further comprising applying a cushioning layer about an outer surface of the at least one optical fiber.

30. The method of claim 29, wherein the cushioning layer at least substantially fills an area between the inner surfaces of the plurality of shaped profiles and the outer surface of the at least one optical fiber.

31. The method of claim 28, further comprising applying a liquid polymer layer about an outer surface of the at least one optical fiber, such that the liquid polymer layer at least substantially fills an area between the inner surfaces of the plurality of shaped profiles and the outer surface of the at least one optical fiber.

32. The method of claim 31, further comprising curing the liquid polymer layer.

33. The method of claim 32, wherein the liquid polymer layer is comprised of silicon.

34. The method of claim 24, wherein said forming comprises forming the inner surfaces of the plurality of shaped profiles such that the enclosure has a shape chosen from the group consisting of circular, polygonal and star shaped.

35. The method of claim 34, wherein said forming comprises forming the outer surfaces of the plurality of shaped profiles such that said the outer surfaces combine to form a shape chosen from the group consisting of circular, polygonal and rectangular.

36. The method of claim 24, wherein said forming comprises forming plurality of shaped profiles to have a shape chosen from the group consisting of an arched pie shape, a keystone shape, a triangular shape, and a rectangular shaped.

37. The method of claim 24, wherein the cable component is disposed in a wireline cable for use in an oil and gas well.
